(19) United States
(12) Patent Application Publication
(10) Pub. No.: US 2010/0067332 A1
(43) Pub. Date: Mar. 18, 2010

(54) Watch with a Time Zone Display

(75) Inventor: Patrick Kury, Langendorf (CH)

Correspondence Address: THE WEBB LAW FIRM, P.C., 700 KOPPERS BUILDING, 436 SEVENTH AVENUE, PITTSBURGH, PA, 15219, US

(73) Assignee: ETERNA AG UHRENFABRIK, Grenchen (CH)

(21) Appl. No.: 12/595,144

(22) PCT Filed: Apr. 11, 2008
(86) PCT No.: PCT/EP2008/054453

§ 371 Date: Nov. 20, 2009

(30) Foreign Application Priority Data
Apr. 11, 2007 (CH) 0592/07

(51) Int. Cl. G04B 19/22

(52) U.S. Cl. 368/21

(57) ABSTRACT

A watch includes a conventional hour hand and minute hand. The watch also includes a time zone display with a window in which information regarding a time zone is placed on a disc. This time zone includes a time display comprising at least one hour display, which may also be realized by a window in that an hour display for the displayed time zone is placed on a disc. A crown with a depressor is then provided, which is mechanically connected to the time zone display or the time display for the displayed time zone such that, by actuating the depressor, at least the hour hand may be brought into synchronization with the time zone determined by the time zone display. In this manner, the new local time may be set according to a predetermined time zone by a single operation without stopping the clockwork.

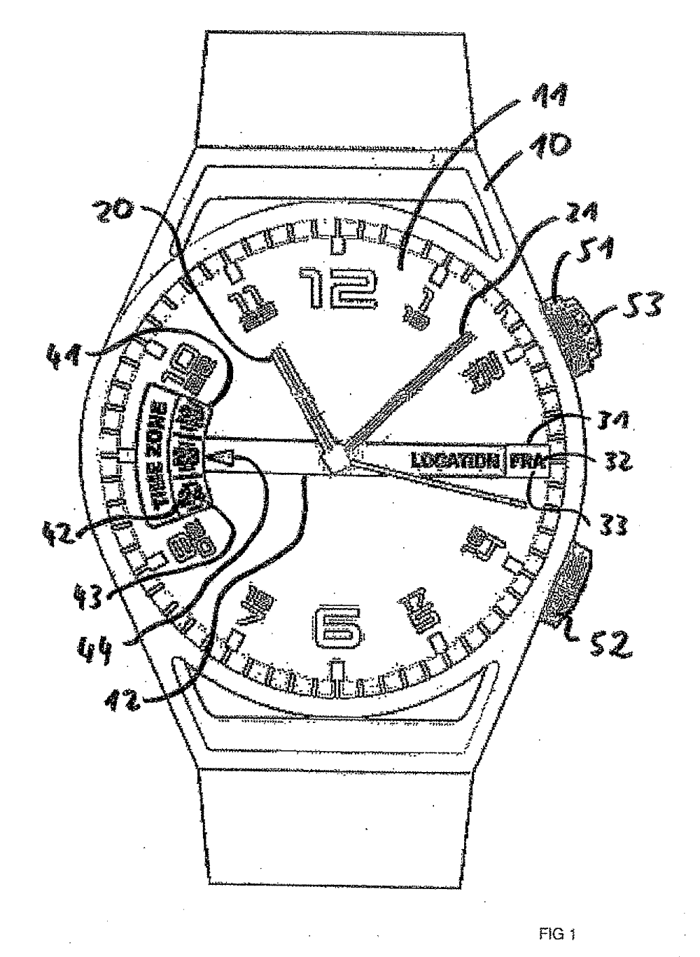

### TECHNICAL FIELD OF THE INVENTION

The invention relates to a watch having an hour hand, having a minute hand, having a time zone display and having a time display, comprising at least an hour display, for said displayed time zone.

### PRIOR ART

A watch having the features of the preamble to claim 1 is known from CH 563 608. The time zone display comprises a window, beneath which there turns a disk on which names of an important city of each particular time zone are printed, of which one respectively is displayed in the window. The watch further has standard hour hands and minute hands, which display the base time. In addition, an hour display is provided, which comprises an hour disk, on which the hours are imprinted as numerals, and a window, in which respectively a numeral can be read. The hour disk is rotated upon each change of hour of the base time, so that the next hour is displayed in the window.

A further watch having the features of the preamble to claim 1 is known from CH 684 618. In this, on the one hand, the disks for the time zone display and the time display for the displayed time zone can be adjusted together for synchronous changing of the time zone, while, on the other hand, the disk of the time display for the displayed time zone can be separately adjusted for setting of the time in a time zone.

In all cases, the display of the hour display and minute display remains always in base time.

### SUMMARY OF THE INVENTION

Starting from this prior art, the object of the invention is to define a watch of the type stated in the introduction, with which a direct changing of the hand display to local time is possible for the user. Local time is here regarded to be the time which is obtained through the time indicated in the time zone display.

This object is achieved according to the invention with the features of claim 1, the watch having at least a conventional hour hand. It additionally boasts a time zone display, for example having a window in which a reference to a time zone is mounted on a disk. Belonging to this time zone is a time display comprising at least an hour display, which time display, for example, can likewise be realized by a window in which an hour display for said displayed time zone is mounted on a disk. In this case, a crown is then provided, having a push piece which is mechanically connected to the time zone display or to the time display for said displayed time zone, so that, through actuation of the push piece, at least the hour hand can be brought into synchronization with the time zone prespecified by the time zone display. The new local time according to a preset time zone can thus be set by a single actuation, without stoppage of the watch movement.

Further advantageous embodiments are characterized in the subclaims.

### BRIEF DESCRIPTION OF THE DRAWING

The single drawing shows a top view of a dial of a watch according to an illustrative embodiment of the invention.

### DETAILED DESCRIPTION OF AN ILLUSTRATIVE EMBODIMENT

The illustrative embodiment of the invention shows a watch which allows the simultaneous and independent display of two times from different time zones.

The watch is represented schematically with a housing 10 and a dial 11. Brushing over the dial 11 are a conventional hour hand 20 and an associated minute hand 21 arranged concentrically thereto. These hands 20, 21 usually display the base time.

At the 3 o'clock position, the sign “Location” is disposed next to a time zone window 31. In the time zone window 31 appears a time zone reference 32, for example FRA for Frankfurt, LON for London, or some other abbreviation, for example relating to the standard city codes or that of an important airport of said time zone. This may take the form of some other reference to the time zone, such as a national flag or a spelt-out city or place name. 24 time zone references 32 exist on the underlying disk 33. Instead of a window 31, all time zone references 32 can also be visible on the underlying disk 33, or can be recognizable behind a translucent region of the dial. The advantage of direct recognition for the user is offset by the reduced clarity.

At the 9 o'clock position, the term “Time Zone” is disposed next to a window 41. In the window 41 a disk is visible, on which times 42, symbolized by numerals from 1 to 24, are imprinted. The window 41 here has a size which allows the display of three time numerals, an arrow 44 pointing to the central position in the window 41.

In an illustrative embodiment, the disk 43 rotates at half the angular velocity, otherwise synchronously with the hour hand 20. However, it is also possible, for example, that just a digital display 42 is visible and that this adjusts itself incrementally, upon the change of hour of the hour hand 20, by a 15-degree rotation of the disk 43.

Finally, at least two crowns 51 and 52 are disposed on the housing, here at the 2 o'clock position and the 4 o'clock position.

The screwed crown 52 at the 4 o'clock position is designed in a known manner for the manual winding of an automatic watch movement and of the hand setting for the hands 20 and 21. The crown 51 comprises a screwed crown 51 with push piece 53 at the 2 o'clock position, the function of which is described below.

On the dial 11 can be found said displays, which can be operated by the screwed crown 51 at the 2 o'clock position:

1. The time zone reference 32 next to the term “Location” at the 3 o'clock position, which displays the respective reference location of a chosen time zone.

2. The times 42 next to the term “Time Zone” at the 9 o'clock position, which display the current time of the time zone chosen under “Location” at the 3 o'clock position (C).

Since the working of the screwed crown 52 at the 4 o'clock position corresponds to those of known watches, this is not discussed in greater detail here. It boasts two pull-out positions: manual winding and hand setting. It remains to be mentioned that, in the hand-setting position of the crown 52, the digital display 42 is adjusted jointly with the hands 20 and 21 to be adjusted, since these two displays are mechanically interconnected. Here the user must be sure to bear in mind that the digital display 42 embraces 24 hours, so that a set time must be adjusted with the 12-hour hands, where necessary, by a further 12 hours.

One of the two times is here conventionally represented via the hands 20 and 21, the other mechanically via the permanently revolving, digital display 42 of the disk in the window 41 according to the set reference location 32 on the disk 33. These two elements form an individual unit on the dial 11, in that they visually stand out from the rest of the dial 11 by virtue of lines 12.

The various possibilities of use in a watch according to the described illustrative embodiment are indicated below.

In normal operation, one of the two times is represented via the hands 20 and 21, the other via the continuously revolving, digital display 42 according to the set reference location on the disk 33, which is fixed. Through first-time actuation of the push piece 53 on the crown 51, the hand time is synchronized with the display 42 on the disk 43, without stopping the hand time, represented by the hands 20 and 21. Through pressing of the knob 53, the necessary motion and kinetic energy is hereupon transferred to the mechanics, that the hour hand 20 moves in accordance with the set time. As a result of the 12-hour display of a hand, no distinction is made, of course, between 11 a.m. and 11 p.m. Advantageously, the hand 20 is advanced in the clockwise direction, though the motion can also be defined such that, when the time is put back by 1 to 5 hours by pressing of the knob 53, the hour hand 20 runs counterclockwise into its new end position. The motion occurs in synchronization with the ongoing motion of the disk 43.

This function is applicable both in purely mechanical and in analog quartz watches, since, because of the coupled drive mechanism of the hand 20 (and 21) and disk 43, it is simply a case of releasing the drive of the hand 20 (and/or 21) for the period of adjustment to the new time zone, while the drive continues to be coupled to the disk 43. When a new time zone is set via the disk 33, the disk 43 is then decoupled and is set with the disk 33; the time display 20/21, however, continues running.

It is also possible in principle to move solely the hour hand 20 by synchronization relative to the time zone display 32, since this too shows the reference time.

This function allows the wearer of the watch to transfer the previously chosen zone time (zone selected via the disk 33, previous representation of the zone time by the disk 43), as the so-called main time or local time, to the hands 20 and 21, without stoppage of the watch movement, when the wearer, for example, has arrived after a lengthy journey at the destination airport in the other time zone. Compared with known watches, the advantage is obtained that the crown 52 no longer has to be pulled in order to manually readjust the hands 20 and 21. Moreover, the watch movement was in each case stopped and the hands 20 and 21 had to be reset on the basis of a reference time ascertainable from an external source.

For the adjustment of the time zone display 32, the screwed crown 51 is unscrewed, whereafter this must additionally be pulled into a first position in order to be able to alter the settings of the time zone disk 33. This procedure is advantageous in order to prevent an inadvertent and undefined adjustment. It is thereby also possible to give the wearer a clear indication that the adjustment function is activated. Through turning of the crown 51, the disk 33 is then rotated, degree-rotations advantageously being respectively possible. This corresponds to an adjustment of the reference locations 32, which advantageously is possible in both directions. This motion of the disk 33 gives rise, in known manner, to a repositioning of the display disk 43. During this manipulation, the crown 51 remains unscrewed. It is hereby mechanically ensured that the push piece 53 is inactive. This helps to prevent incorrect manipulation by the wearer. Once the desired reference location 32 has been chosen, the crown 51 itself is pressed again and screwed in place, in particular to ensure water tightness.

The watch function which has just been described allows the wearer, for example, to set a new time zone 32 already at the departure airport or in-flight and to make this run permanently (by means of the display 42) and parallel to the hand time 20, 21.

A summary of the functional combinations between crown 51 and push piece 53 is represented in the following table:

| Position of | Position of | |
|---|---|---|
| crown 51 | push piece 53 | Description |
| screwed in | unpressed | Time under time zone display 42 |
| | | runs according to the chosen |
| | | reference location 32 parallel |
| | | to the hand time 20/21 |
| unscrewed | inactive | — |
| unscrewed and | inactive | Adjustment of the reference |
| pulled | | location 32 with automatic |
| | | repositioning of the time zone |
| | | display 42 through turning of |
| | | the crown 51 in one of the two |
| | | possible directions |
| pressed and | unpressed | Time of the time zone display 42 |
| screwed in | | runs according to the reference |
| | | location 32 parallel to the hand |
| | | time 20/21 |
| pressed and | pressed | Synchronization of the hand time |
| screwed in | | with the time zone display 42 |
| | | according to settings 32 and 42 |

To the person skilled in the art it is clear from the above that the time zone reference 32 can also be provided on a separate disk which is not concentric with the hands 20 and 21. In electronic watches, the time zone reference 32 can also be realized with a display such as an alphanumeric LCD display.

The same applies to the times 42 of the time display of the second time zone, which, firstly, can be provided on a separate disk which is not concentric with the hands 20 and 21. In electronic watches, the times 42 of the time display of the second time zone can also be realized with an electronic display, in particular with the same display, for example an LCD display, as with the time zone reference 32. Thus time zones with a half-hour differential can also easily be set. In this case, the joint movement of the minute hand 21 is essential.

Essential to the function is the pressing of a crown (here crown 53) for realizing the synchronization of the hand time 20, and, where necessary, 21, with the time zone display 42 according to the presets 32 and 42. In electronic watches, the pressing of a knob can take over the function of the pressing of the crown, so that the hands 20, 21 are then moved electrically.

1-6. (canceled)

7. A watch comprising:
an hour hand,
a minute hand,
a time zone display for displaying different time zones,
a time display, and
a crown,
wherein the time display comprises at least an hour display for a displayed time zone, wherein the crown has a push piece which is mechanically connected to the time zone display or to the time display for said displayed time zone, so that, through actuation of the push piece, at least the hour hand can be brought into synchronization with the time zone prespecified by the time zone display.

8. The watch as claimed in claim 7, wherein, during actuation of the push piece, the time display for said displayed time zone continues to be driven by the watch movement.

9. The watch as claimed in claim 7, wherein the crown, in the pulled-out state, is designed for the setting of said displayed time zone, wherein the push piece is blocked by the crown in the pulled-out state for actuation of the push piece.

10. The watch as claimed in claim 7, wherein a further crown is provided, with which the hour hand and the minute hand can be set, upon which setting the time display for said displayed time zone is also jointly set.

11. The watch as claimed in claim 7, wherein the time zone display comprises a disk having time zone designations mounted thereon, which are visible in a window.

12. The watch as claimed in claim 7, wherein the time display, comprising at least an hour display, for said displayed time zone comprises a disk having hour designations mounted thereon, at least one of which is visible in a window.
